(19) United States
(12) Patent Application Publication
(10) Pub. No.: US 2002/0026337 A1
(43) Pub. Date: Feb. 28, 2002

(54) Rental-car reservation method, rental-car reservation system, and recording medium saved rental-car reservation program

(76) Inventor: Hiroshi Sasaki, Tokyo (JP)

Correspondence Address: McGinn & Gibb, PLLC., Suite 200, 8321 Old Courthouse Road, Vienna, VA, 22182-3817, US

(21) Appl. No.: 09/933,005

(22) Filed: Aug. 21, 2001

(30) Foreign Application Priority Data
Aug. 23, 2000 (JP) 2000/253209

(51) Int. Cl. G06F 17/60

(52) U.S. Cl. 705/5

(57) ABSTRACT

A rental-car reservation method, a rental-car reservation system, and a recording medium wherein a rental-car reservation program is recorded are provided. A www server and a data control server receive rental-car reserving information from a customer terminal through a network. On the basis of the reserving information, a data control server directs a rental-car information control server, which is set in a car-rental agent, to allocate a rental car. On the basis of the directions of allocating a rental car, an employee in the car-rental agent allocates a rental car at an appointed location and at an appointed date, and goes to an appointed location at appointed date in order to take back the rental car. Therefore it becomes possible to promote customer's convenience in using a rental car.

### BACKGROUND OF THE INVENTION

The present invention relates to a rental-car reservation method, a rental-car reservation system, and a recording medium wherein a rental-car reservation program is saved, which make it possible to promote customer's convenience when a customer uses a rental car.

### DESCRIPTION OF THE RELATED ART

In using a rental car, it is often the case that a customer calls a branch office of a car-rental agent and so forth, visits the branch office directly, or accesses a Web site homepage for rental-car reservation which is opened on the Internet by the car-rental agent. In reserving a rental car, the customer is required to offer customer information such as his/her full name, address or residence, phone number, and license number, and reserving information such as a type of car of his/her request, a pick up date and a return date. At this time, it is often the case that the pick up date and the return date are limited during working hours of the car-rental agent. Besides, in using a rental car, the customer is sometimes required to become a member of the car-rental agent.

By adjusting allocation of rental cars between branch offices, the car-rental agent allocates rental cars so as to make it possible to satisfy contents of reservation. At this time, it is often the case that the car-rental agent adjusts allocation of rental cars by exchanging information about allocation of rental cars among each terminal for allocation of rental cars which is set in each of the branch offices. In advance of handing a rental car, the car-rental agent calls the customer or sends by e-mail to him/her in order to confirm the contents of the reservation such as the pick up date and the return date (rental term), and the type of car. In the case where it is impossible to satisfy his/her request, the car-rental agent informs the customer to the effect that the car-rental agent cannot cater to his/her request. Then the customer applies to a request for use of a rental car again by modifying conditions.

Before the use of the requested rental car, the customer visits the branch office and rents a car. Then, after he/she used the car, in time for the return date, he/she returns the car to the branch office of the car-rental agent. In the case of returning the car to another branch office which differs from the branch office in charge, the car-rental agent charges the customer with additional prescribed commission fee (commission fee for dropping off).

In the conventional business operation as described above, the customer may feel inconvenience because he/she has to visit the branch office directly in renting and returning a car.

Besides, it is often the case that a pick up date and a return date of using a rental car are limited during working hours of the car-rental agent. Thereby the customer may feel inconvenience when he/she requires a rental car out of working hours. For example, in the case where the customer requires a rental car from early in the morning, he/she has to visit a branch office of a car-rental agent at least during the previous working hours. In this case, it is difficult for office workers and others, who do not have much time, to visit a branch office for a rental car. Therefore they have no other choice but to give up use of a rental car.

### SUMMARY OF THE INVENTION

It is therefore an object of the present invention to provide a rental-car reservation method, a rental-car reservation system, and a recording medium wherein a rental-car reservation program is saved, which make it possible to promote customer's convenience in using a rental car.

According to a first aspect of the present invention, for achieving the objects mentioned above, there is provided a rental-car reservation method wherein:

a car-rental fixing-up agent directs a car-rental agent to allocate a rental car on the basis of reserving information from a customer; and

the car-rental agent allocates the rental car at an appointed location at an appointed date, and goes to an appointed location at an appointed date so as to take back the rental car on the basis of the direction of allocating the rental car.

According to a second aspect of the present invention, the car-rental fixing-up agent inquires of a plurality of car-rental agents whether or not it is possible to allocate the rental car so as to satisfy contents of the reservation, and chooses a car-rental agent which allocates the rental car for the customer on the basis of results of replies from the plurality of the car-rental agents.

According to a third aspect of the present invention, there is provided a rental-car reservation system including:

a rental-car information control server which controls information of operating condition of rental cars; and

fixing-up servers which ask the rental-car information control server to allocate a rental car according to rental-car reserving information from a customer terminal. Here, the customer terminal means a terminal of a cellular phone or a communication terminal which is typified by a personal computer.

According to a fourth aspect of the present invention, there are a plurality of rental-car information control servers, and the fixing-up servers choose one of the rental-car information control servers according to the reserving information, and asks the chosen rental-car information control server to allocate the rental car. Here, the fixing-up servers inquires of each of the plurality of the rental-car information control servers whether or not it is possible to issue instructions of allocating the rental car so as to satisfy contents of the reservation, and chooses the certain rental-car information control server on the basis of the results of the replies from each of the rental-car information control servers.

According to a fifth aspect of the present invention, leased lines are employed for connecting the fixing-up servers to the rental-car information control server(s). Therefore it is possible for the fixing-up servers to respond to the customer terminal, and to secure customers' private information from leaking out, which is transmitted and received between the fixing-up servers and the rental-car information control server(s).

According to a sixth aspect of the present invention, there is provided a recording medium in which rental-car reservation program for rental-car reservation is recorded, including steps of:

taking rental-car reserving information from a customer terminal;

inquiring of a plurality of rental-car information control servers each of which controls allocation of rental cars whether or not it is possible to issue instructions of allocating a rental car so as to satisfy contents of the reservation;

choosing one of the rental-car information control server which can allocate the rental car so as to satisfy the contents of the reservation on the basis of the results of the replies from each of the rental-car information control servers; and

directing the chosen rental-car information control server to allocate the rental car.

### BRIEF DESCRIPTION OF THE DRAWINGS

The objects and features of the present invention will become more apparent from the consideration of the following detailed description taken in conjunction with the accompanying drawings in which:

FIG. 1 is a structural block diagram showing a configured example of a rental-car reservation system according to the present invention;

FIG. 2 is an explanation drawing showing an example of a front screen;

FIG. 3 is an explanation drawing showing an example of an input screen;

FIG. 4 is an explanation drawing showing an example of a confirmative screen;

FIG. 5 is an explanation drawing showing an example of a confirmative screen;

FIG. 6 is an explanation drawing showing an example of a message screen;

FIG. 7 is a flowchart to explain operation of a www server 120;

FIG. 8 is an explanation drawing showing an example of an input screen;

FIG. 9 is an explanation drawing showing an example of a message screen;

FIG. 10 is an explanation drawing showing an example of a message screen;

FIG. 11 is an explanation drawing showing an example of a confirmative screen;

FIG. 12 is an explanation drawing showing an example of an select screen;

FIG. 13 is an explanation drawing showing an example of an input screen;

FIG. 14 is an explanation drawing showing an example of an select screen;

FIG. 15 is an explanation drawing showing an example of an input screen;

FIG. 16 is an explanation drawing showing an example of a confirmative screen;

FIG. 17 is an explanation drawing showing an example of a message screen;

FIG. 18 is an explanation drawing showing an example of information which is transmitted from a www server 120 to a customer terminal 110;

FIG. 19 is an explanation drawing showing an example of information which is transmitted from a data control server 130 to a rental-car information control server 140; and

FIG. 20 is a structural block diagram showing a configured example of a rental-car reservation system according to the present invention.

### DESCRIPTION OF THE PREFERRED EMBODIMENTS

Referring now to the drawings, embodiments of the present invention are explained in detail.

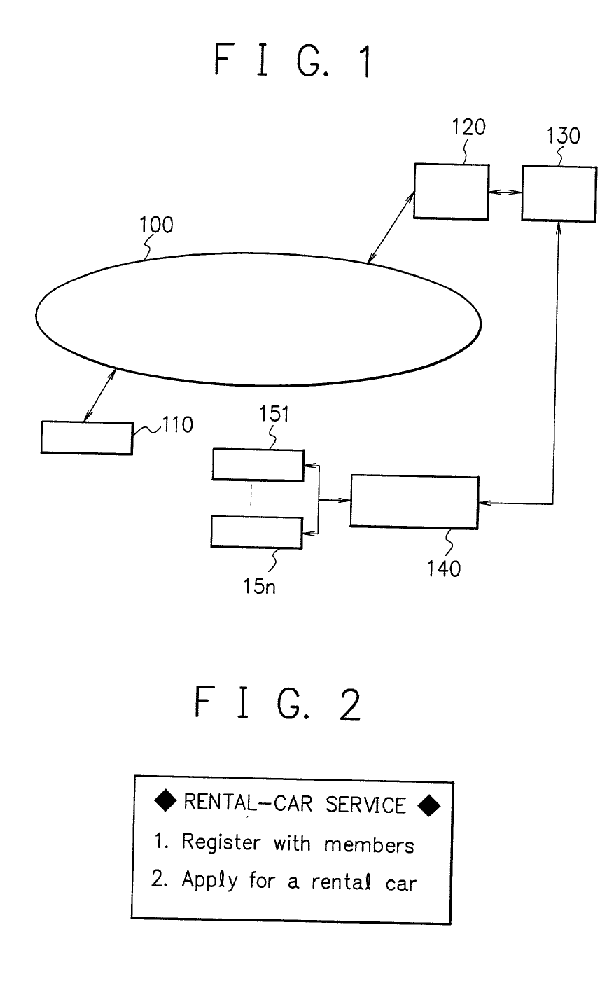

First, there is an explanation of a first embodiment of the present invention. FIG. 1 is a structural block diagram showing a configured example of the rental-car reservation system according to the present invention.

In the rental-car reservation system as shown in FIG. 1, a customer terminal 110 and a www server 120 are connected through a network 100 which is typified by the Internet. A data control server 130 is connected to the www server 120. A rental-car information control server 140 is connected to the data control server 130. For the connection between the data control server 130 and the rental-car information control server 140, leased lines which are typified by leased lines for TCP/IP communications are employed, for example. The leased lines are employed so that the data control server 130 may respond instantly to inquiries from the customer terminal 110, and so as to secure customers' private information from leaking out, which is transmitted and received between the data control server 130 and the rental-car information control server 140.

Here, fixing-up servers described in the claims according to the present invention are equivalent to the www server 120 and the data control server 130. And also a rental-car information control server described in the claims is equivalent to the rental-car information control server 140.

The www server 120 receives information from the customer terminal 110 through the network 100, and transmits and receives necessary information between the www server 120 and the data control server 130. The customer terminal 110 means, for example, a cellular phone in which a function of connecting to the Internet is equipped. The customer terminal 110 may equip a function which makes it possible to use such as i-mode provided by NTT DoCoMo, Inc. Of course, the customer terminal 110 may be a fixed terminal of a computer and so forth.

The data control server 130 classifies information received from the customer terminal 110 into customer information and reserving information concerning reservation of a rental car in response to instructions from the www server 120. The data control server 130 also saves the customer information in a customer information data base, and the reserving information in a reserved information data base. Here, it is assumed that the customer information data base and the reserved information data base are set in the data control server 130.

The data control server 130 transmits and receives necessary information between the data control server 130 and the rental-car information control server 140 on the occasion of reserving a rental car. The www server 120 and the data information control server 130, for example, are servers for workstation, both of which are set in a rental-car fixing-up agent. The www server 120 may be identical with the data control server 130. Here, a program for reserving a rental car is saved in the www server 120 and the data control server 130. Or the program of the kind may be saved in a recording medium such as a portable floppy disk or a CDROM. Therefore, it is possible to load the program using the recording medium such as the floppy disk or the CDROM into the www server 120 and the data control server 130. Here, the rental-car fixing-up agent means an agent who fixes up or conciliates a car-rental agent for customers.

The rental-car information control server 140 is, for example, a server for workstation, which is set in the car-rental agent. The rental-car information control server 140 transmits and receives necessary information between the rental-car information control server 140 and terminals for allocation of rental cars 151-15n, which are for allocating rental cars and are set in branch offices of the car-rental agent. As an example of the terminals for allocation of rental cars, there are communication terminals of personal computers and so forth.

Next, operation of this embodiment will be explained. On the occasion of reserving a rental car, a customer inputs URL of the www server 120 into the customer terminal 110 by dial operation and so forth. Then the www server 120 provides a front screen as shown in FIG. 2 on a display (a display panel) of the customer terminal 110. FIG. 2 is an explanation drawing showing an example of the front screen.

The customer is required to become a member of the rental-car fixing-up agent on the occasion of reserving a rental car. Here, the customer registers with the rental-car fixing-up agent. The customer chooses “1. Register with members” by cursor operation and so forth on the front screen. In the case where the customer has already registered with the rental-car fixing-up agent, the customer may chose “2. Apply for a rental car” on the select menu. Operation after choosing the “2. Apply for a rental car” on the select menu will be described later.

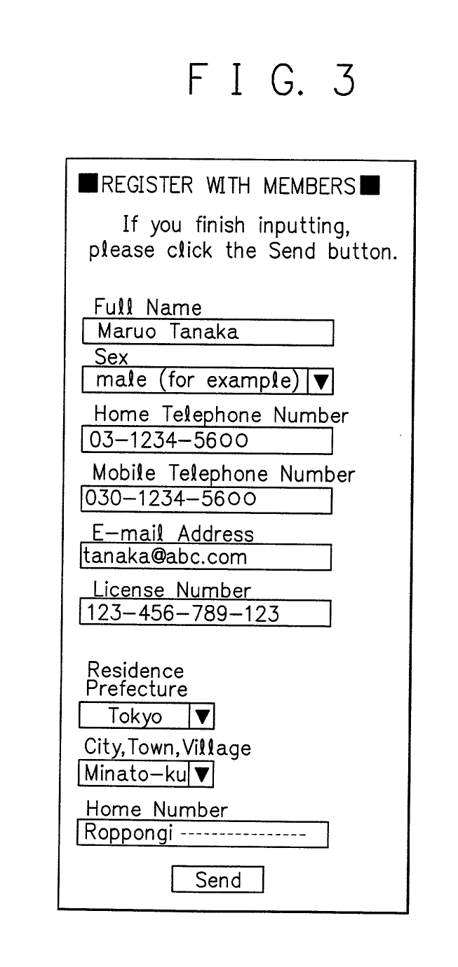

Then the www server 120 provides an input screen as shown in FIG. 3 on the display of the customer terminal 110. FIG. 3 is an explanation drawing showing an example of the input screen. Here, it is assumed that a terminal of a cellular phone is employed for the customer terminal. In the case where the display of the cellular phone cannot show the full input screen as shown in FIG. 3, the customer can catch the full input screen by a scrolling function. The customer inputs customer information, which is necessary for registering with members, such as customer's full name, sex, telephone number, e-mail address, license number and address into the customer terminal 110 on the input screen by dial operation and so forth. After the customer finishes inputting the customer's information, he/she presses (clicks) the “Send” button shown on the bottom of the input screen by dial operation or cursor operation and so forth. The customer information is transmitted from the customer terminal 110 to the www server 120 through the network 100. Hereinafter, cursor operation or dial operation and so forth are used in inputting on the screen of every sort and kind shown on the display of the customer terminal 110.

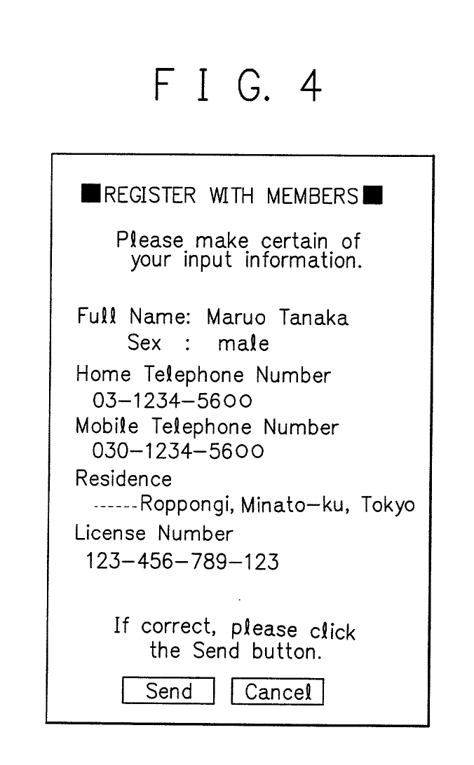

The www server 120 provides a confirmative screen as shown in FIG. 4 on the display of the customer terminal 110. FIG. 4 is an explanation drawing showing an example of the confirmative screen. The customer presses the “Send” button if he/she confirms that the inputted customer information agrees with the contents shown on the confirmative screen. On the other hand, the customer presses the “Cancel” button if he/she wants to change the inputted customer information. Then information of chosen button is transmitted from the customer terminal 110 to the www server 120.

When the “Cancel” button is pressed, the www server 120 provides the input screen as shown in FIG. 3 on the display of the customer terminal 110. The customer inputs different customer information again on the input screen.

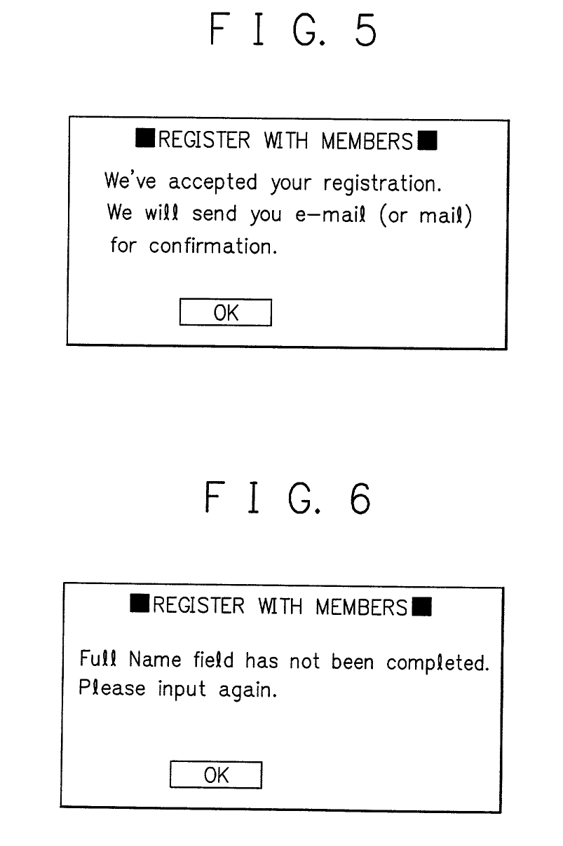

When the “Send” button is pressed, the www server 120 provides a confirmative screen as shown in FIG. 5 on the display of the customer terminal 110. FIG. 5 is an explanation drawing showing an example of the confirmative screen. The customer presses the “OK” button shown on the confirmative screen. The www server 120 notifies the data control server 130 of the customer information and directs the data control server 130 to save the customer information. Then the data control server 130 records the customer information in the customer information data base. The www server 120 also transmits e-mail to the customer terminal 110 in order to inform the customer that his/her registration of members has been accomplished.

Here, the www server 120 checks whether or not there is any misdescription or missing out concerning the inputted customer information on the screen. As an example of misdescription or missing out, there is a case that a full name is not filled in and so forth. In the case where there are some fields of misdescription or missing out, the www server 120 provides a message screen as shown in FIG. 6 on the display of the customer terminal 110. FIG. 6 is an explanation drawing showing an example of the message screen. After the customer presses the “OK” button shown on the message screen, www server 120 provides the input screen as shown in FIG. 3 on the display of the customer terminal 110. Then the customer inputs customer information correctly again.

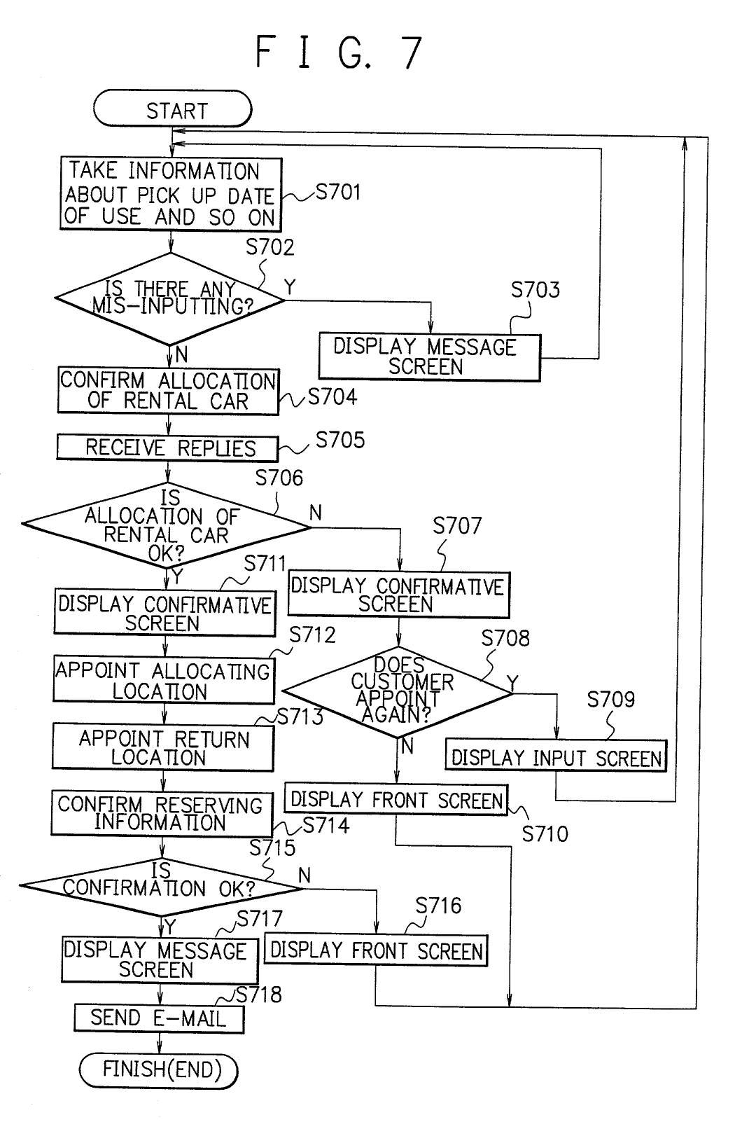

Next, the customer reserves a rental car. The customer chooses “2. Apply for a rental car” on the front screen shown on the display of the customer terminal 110. Here, FIG. 7 is a flowchart to explain operation of the www server 120.

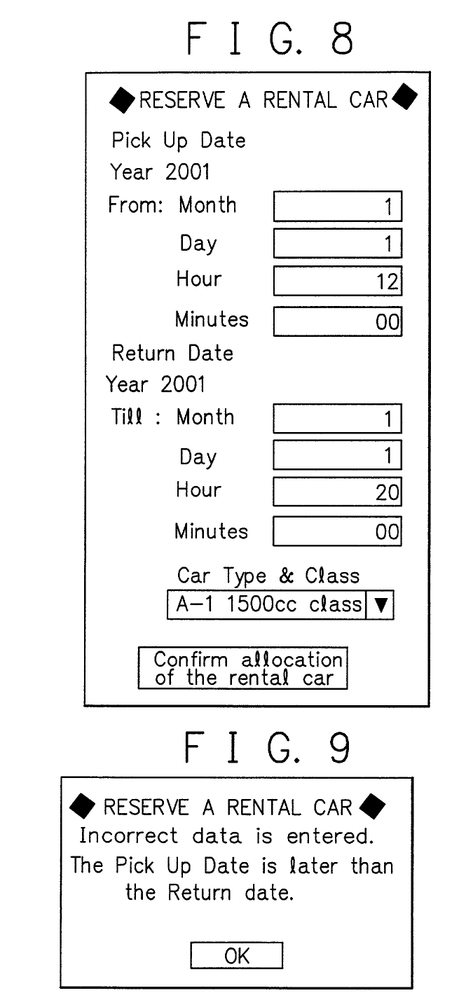

The www server 120 provides an input screen as shown in FIG. 8 on the display of the customer terminal 110. FIG. 8 is an explanation drawing showing an example of the input screen. The customer inputs a pick up date, a return date, and a car type and class of the customer's request on the input screen. After finishing inputting the reserving information as described above, the customer presses the “Confirm allocation of the rental car” button shown on the input screen. Then the customer terminal 110 transmits the reserving information to the www server 120.

The www server 120 receives the reserving information (Step S701). Then the www server 120 checks whether or not there is any misdescription or missing out concerning the reserving information inputted on the screen (Step S702). As an example of misdescription or missing out, there is a case that a pick up date is named on a later date than a return date.

In the case where there are some fields of misdescription or missing out, the www server 120 provides a message screen as shown in FIG. 9 on the display of the customer terminal 110 (Step S703). FIG. 9 is an explanation drawing showing an example of the message screen. The customer presses the “OK” button shown on the message screen. Then the www server 120 provides the input screen as shown in FIG. 8 on the display of the customer terminal 110. The customer inputs the reserving information correctly again. Then the www server 120 executes processes of steps from S701.

In the case where there is no misdescription or missing out (incorrect data inputting), the www server 120 directs the data control server 130 to confirm allocation of a rental car (Step S704). Here, the www server 120 notifies the data control server 130 of the reserving information. The data control server 130 transmits the reserving information to the rental-car information control server 140. Thereby the data control server 130 inquires of the rental-car reservation control server 140 whether or not it is possible to allocate a rental car so as to satisfy the contents of the reserving information.

The rental-car information control server 140 transmits and receives information between the rental-car information control server 140 and at least one of terminals for allocation of rental cars 151-15n, judging whether or not it is possible to allocate a rental car so as to satisfy the contents of the reserving information, and transmitting result of the judgment to the data control server 130. Then the data control server 130 receives the result of the judgment and notifies the www server 120 of the result of judgment. Thereby the www server 120 takes the result of the judgment made by the rental-car information control server 140 (Step S705). On the basis of the result of the judgment, the www server 120 judges whether or not it is possible to allocate a rental car so as to satisfy the contents of the reserving information (Step S706). In the case where the rental-car information control server 140 keeps track of sequential rental-car operating condition of each branch office, there is no need to communicate information of rental cars between the rental-car information control server 140 and each of the terminals for allocation of rental cars 151-15n at this stage. This is because the rental-car information control server 140 can immediately return an answer of accepting the reservation or failing to reserve when the data control server 130 inquires of the rental-car information control server 140.

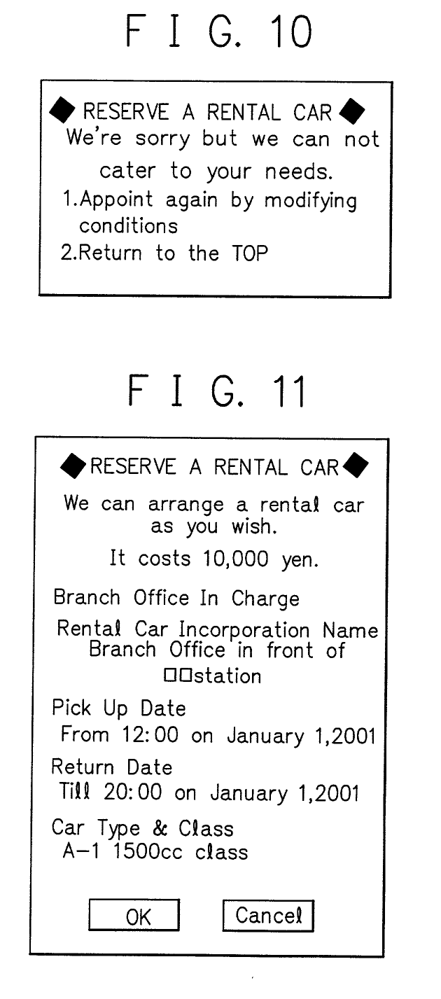

In the case where it is impossible to allocate a rental car, the www server 120 provides a message screen as shown in FIG. 10 on the display of the customer terminal 110 (Step S707). FIG. 10 is an explanation drawing showing an example of the message screen. The customer chooses one menu between “1. Appoint again by modifying conditions” and “2. Return to the TOP” shown on the message screen. Then information of chosen menu is transmitted from the customer terminal 110 through the www server 120.

The www server 120 judges which menu has bee chosen (Step S708). When “1. Appoint again by modifying condition” is chosen, the www server 120 provides the input screen as shown in FIG. 8 on the display of the customer terminal 110 (Step 709) and executes processes of steps from S701. On the other hand, when “2. Return to the TOP” is chosen, the www server 120 provides the front screen as shown in FIG. 2 on the display of the customer terminal 110 (Step S710), and executes processes of steps from S701.

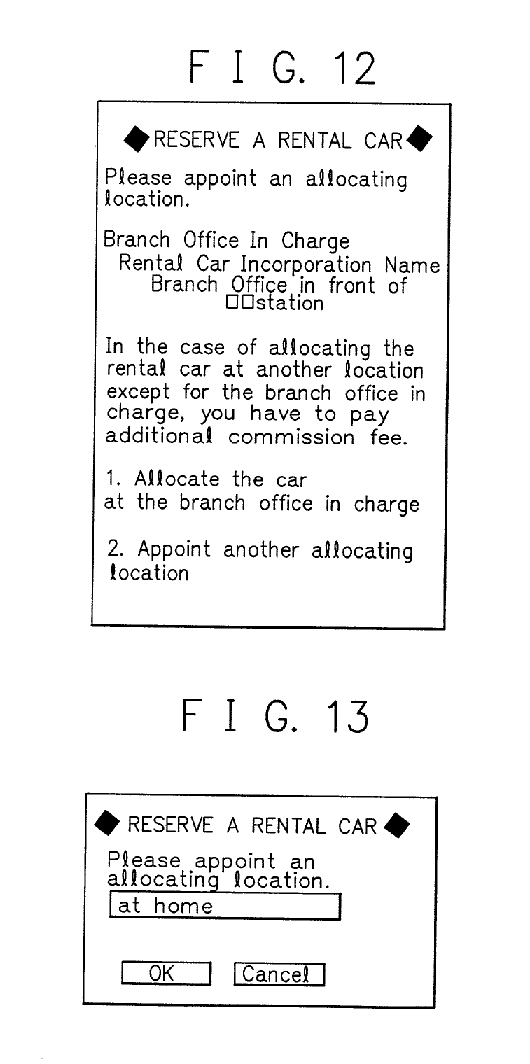

In the case where it is possible to allocate a rental car, the www server 120 provides a confirmative screen as shown in FIG. 11 on the display of the customer terminal 110 (Step S711). FIG. 11 is an explanation drawing showing an example of the confirmative screen. The customer confirms whether or not the inputted reserving information agrees with the contents shown on the confirmative screen. In the case where the inputted reserving information agrees with the contents shown on the confirmative screen, the customer presses the “OK” button. On the other hand, in the case where the inputted reserving information disagrees with the contents shown on the confirmative screen, or the customer wants to modify the contents of the reservation, the customer presses the “Cancel” button. When the “Cancel” button is pressed, the www server 120 provides the input screen as shown in FIG. 8 on the display of the customer terminal 110, and executes processes of steps from S701. When the “OK” button is pressed, the www server 120 provides an select screen as shown in FIG. 12 on the display of the customer terminal 110 (Step S712). FIG. 12 is an explanation drawing showing an example of the select screen.

The customer chooses an allocating location between a branch office in charge and a location where the customer appoints on the select screen. Here, the customer chooses one menu between “1. Allocate at the branch office in charge” and “2. Appoint another allocating location”. When “1. Allocate at the branch office in charge (an another branch office)” is chosen, the customer terminal 110 transmits information of chosen menu to the www server 120.

When “2. Appoint another allocating location” is chosen, the www server provides an input screen as shown in FIG. 13 on the display of the customer terminal 110. FIG. 13 is an explanation drawing showing an example of the input screen. The customer appoints an allocating location. The customer may input a convenient location such as the customer's home, in front of a station, or in front of a supermarket. Also the customer may input an another branch office of the same car-rental agent other than the branch office in charge. If he/she agrees to the inputted allocating location, the customer presses the “OK” button. On the other hand, if he/she wants to change the inputted allocating location, the customer presses the “Cancel” button. When the “Cancel” button is pressed, the select screen as shown in FIG. 12 is shown on the display of the customer terminal 110. Then the customer goes through procedure of appointing a different allocating location again. When the “OK” button is pressed (clicked), the customer terminal 110 transmits information of the inputted allocating location to the www server 120.

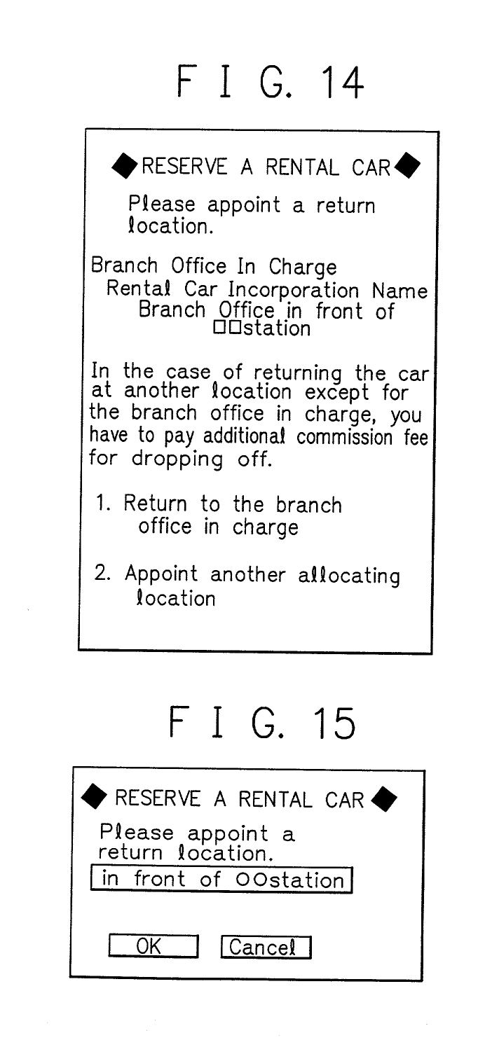

Next, the www server 120 provides an select screen as shown in FIG. 14 on the display of the customer terminal 110 (Step S713). FIG. 14 is an explanation drawing showing an example of the select screen. Then the customer appoints a return location in the same way of appointing the allocating location.

When “1. Return to the branch office in charge” is chosen on the select screen, the customer terminal 110 transmits the information to the www server 120. When “2. Appoint another return location” is chosen, an input screen as shown in FIG. 15 is shown on the display of the customer terminal 110, and the customer inputs a return location. FIG. 15 is an explanation drawing showing an example of the input screen. The customer may input a return location which is convenient in the same way of appointing the allocating location. Then the customer presses the “OK” button or the “Cancel” button.

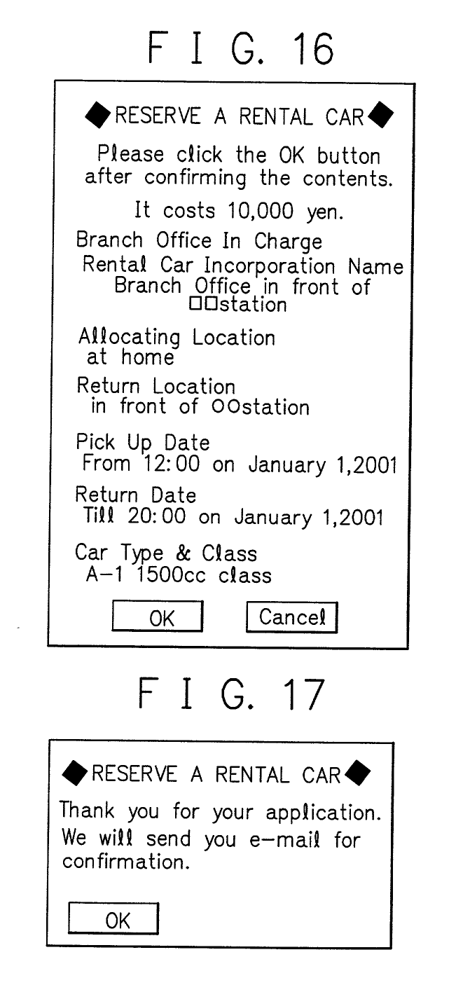

Next, the www server 120 provides a confirmative screen as shown in FIG. 16 on the display of the customer terminal 110 (Step S714). FIG. 16 is an explanation drawing showing an example of the confirmative screen.

In the case where the customer confirms that the inputted reserving information agrees with the contents shown on the confirmative screen, the customer presses the “OK” button. On the other hand, in the case where the customer confirms that the inputted reserving information disagrees with the contents shown on the confirmative screen or wants to go through procedure of reservation again, the customer presses the “Cancel” button. Then the information of chosen button is transmitted from the customer terminal 110 to the www server 120. The www server 120 judges which button has been chosen between the “OK” button and the “Cancel” button (Step S715).

When the “Cancel” button is pressed, the www server 120 provides the front screen as shown in FIG. 2 on the display of the customer terminal 110 (Step S716), and executes processes of steps from S701.

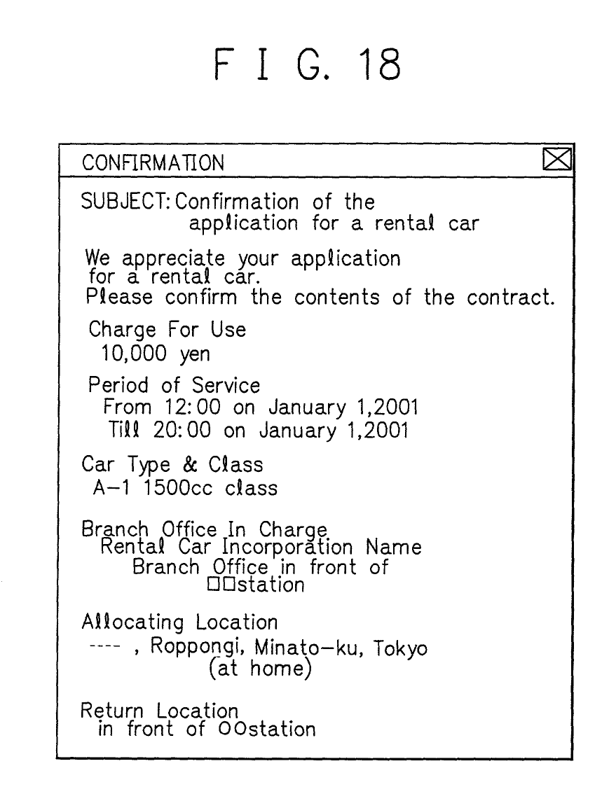

When the “OK” button is pressed, the www server 120 provides a message screen as shown in FIG. 17 on the display of the customer terminal 110 (Step S717). FIG. 17 is an explanation drawing showing an example of the message screen. After the customer presses the “OK” button shown on the screen, the www server 120 notifies the data control server 130 of the reserving information and directs the data control server 130 to record the reserving information. The data control server 130 records the reserving information in the reserved information data base. The www server 120 sends by e-mail for confirmation such as shown in FIG. 18 to the customer terminal 110 (Step S718). FIG. 18 is an explanation drawing showing an example of the information which is transmitted from the www server 120 to the customer terminal 110.

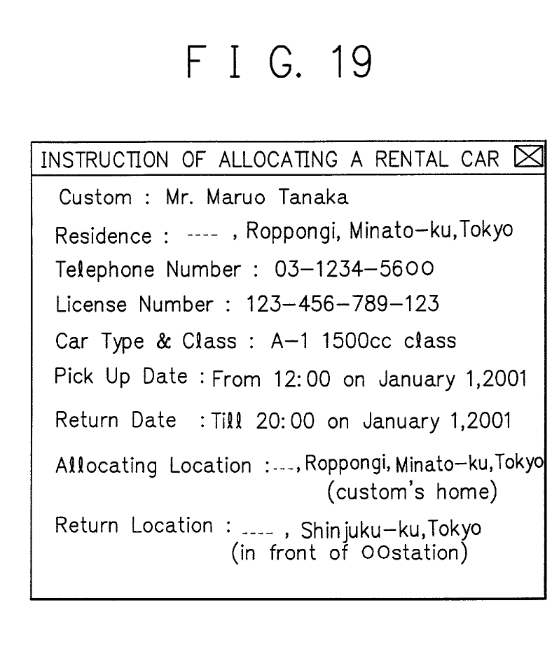

By transmitting information as shown in FIG. 19, the data control server 130 directs the rental-car information control server 140 to allocate the rental car. FIG. 19 is an explanation drawing showing an example of the information which is transmitted from the data control server 130 to the rental-car information control server 140. The rental-car information control server 140 directs a terminal for allocation of rental cars which is set in the branch office in charge to allocate the rental car.

According to the direction to allocate the rental car shown on the terminal for allocation of rental cars of the branch office, an employee in the branch office in charge calls the customer or sends him/her by e-mail in order to confirm the allocating location and the return location. Then the employee allocates the car at the appointed location at the appointed time. For example, in the case where the reserved information is assumed to have the contents shown in FIG. 8, the employee allocates the car whose type is 1500 cc class to the customer's home at 12:00 on Jan. 1, 2001. Then the employee makes contact with the branch office in charge to the effect that he/she has finished allocating the rental car. Then the rental-car information control server 140 transmits the notification of finishing allocating the rental car to the data control server 130.

The customer returns the rental car in time for the appointed return date at the appointed location in usual. The employee goes to the appointed location at the appointed time in order to take back the rental car. For example, in the case where contents of the reserved information is shown as in FIG. 8, the employee stands by in front of a station before 20:00 on Jan. 1, 2001. After the employee takes back the rental car and checks for unrepair of the rental car, the amount of used fuel and so forth, he/she charges the customer prescribed amount of money.

In the embodiment as described above, there is shown a case where the customer registers with the members of the car-rental agent beforehand on the occasion of reserving a rental car. However, the customer may come out with his/her license number, phone number and so forth each time he/she reserves a rental car.

As described above, according to the embodiment of the present invention, the reserving information from the customer terminal 110 is received by the www server 120 through the network 100, and transmitted to the rental-car information control server 140 through the data control server 130. Therefore, it is possible for the customer easily to reserve a rental car regardless of a place and time.

Besides the car-rental agent allocates a rental car at the appointed location according to the reserved information, and takes back the rental car at the appointed location. Therefore, it is possible for the customer to save the troublesome of visiting the branch office of the car-rental agent on the occasion of renting and returning a rental car. Further, even in the case where the customer has to use a rental car early in the morning, the car-rental agent can allocate a rental car at an appointed location regardless of working hours. Thereby the customer can use a rental car without visiting the branch office of the car-rental agent during working hours on the preceding day. Therefore it is possible even for office workers, who do not have much time, to use rental cars at their convenient.

Moreover, by recording reserving information in the reserved information data base in the data control server 130, the car-rental agent can direct the car-rental agent to allocate rental cars according to circumstance of reserved information by customers. For example, it becomes easier to predict which type of cars are frequently used and which branch office is frequently used by customers on holidays. Therefore it is possible to direct the car-rental agent to allocate rental cars appropriately and to increase efficiency of allocating rental cars.

Further, by recording reserving information on the reserved information data base in the data control server 130, it becomes easier to develop stronger customer ties with the car-rental fixing-up agent. For example, the car-rental fixing-up agent can prompt customers to use rental cars by sending direct mail advertising information of new cars and so forth periodically.

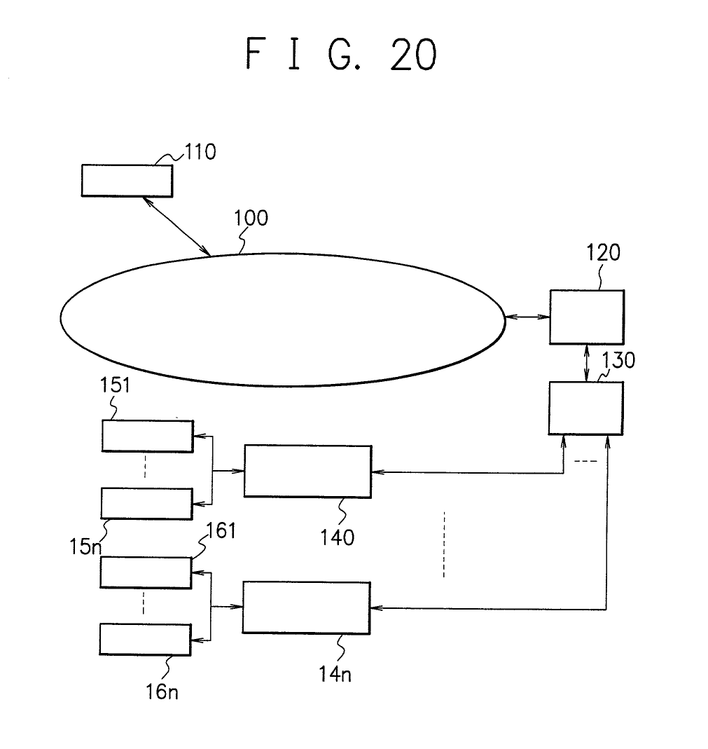

Next, there is an explanation of a second embodiment of a rental-car reservation system of the present invention. FIG. 20 is a constituting block diagram showing an example of structure of a rental-car reservation system of the present invention.

In the rental-car reservation system shown in FIG. 20, rental-car information control servers 140-14n are connected to a data control server 130. Each of the rental-car information control servers 140-14n is set in each of the distinct car-rental agents. Terminals for allocation of rental cars 151-15n are connected to a rental-car information control server 140, and terminals for allocation of rental cars 161-16n are connected to a rental-car information control server 14n.

In the case where the data control server 130 receives reserving information from a customer terminal 110, the data control server 130 inquires of the rental-car information control servers 140-14n whether or not it is possible to allocate a rental car so as to satisfy the contents of the reserving information. Then the data control server 130 receives replies from the rental-car information control servers 140-14n. According to the results of the replies, the data control server 130 chooses one of the rental-car information control servers which can satisfy the contents of the reserving information. Then the data control server 130 directs the chosen rental-car information control server to allocate a rental car. Also in the case where there are plural rental-car information control servers which can satisfy the contents of the reserving information, the data control server 130 may choose an arbitrary rental-car information control server. Besides, in the case where order of priority is established among the rental-car information control servers, the data control server 130 may choose a rental-car information control server according to the order of the priority. By the way, other processes of operation are the same as those of the first embodiment of the present invention.

In this embodiment of the present invention, the plural rental-car information control servers 140-14n are connected to the data control server 130, so that the rental-car fixing-up agent can inquire of the plural rental car agents. Therefore it becomes easier to fix up a car-rental agent which can allocate a rental car so as to satisfy contents of reserving information.

By the way, in the embodiment described above, there is shown a case that the rental-car fixing-up agent chooses a certain car-rental agent from among the plural car-rental agents. In addition to that, the customer may specify a certain car-rental agent in reserving a rental car. Also the customer may line up plural car-rental agents in reserving a rental car. At this time, by narrowing the car-rental agents down according to the agents lined up by the customer, the car-rental fixing-up agent specifies a certain car-rental agent. Besides in the case where order of priority is established to the lined-up car-rental agents, the car-rental fixing-up agent may inquire of the lined-up car-rental agents about possibility of allocating rental cars in order of the established priority.

Further, in the first and second embodiments of the present invention, there is shown a case that the customer terminal 110 means a terminal which can be connected to the Internet. Adding to that, the customer terminal 110 may be a terminal such as a personal computer.

As set forth hereinabove, reserving information transmitted from a customer terminal is received by a fixing-up server(s) through the Internet. According to the reserved information, the fixing-up server(s) directs a rental-car information control server to allocate a rental car. On the basis of the reserved information, a car-rental agent allocates a car at an appointed location at an appointed date and goes to the appointed location in order to take back the rental car at an appointed date. Therefore, a customer can save the trouble of visiting a branch office in using a rental car. Besides, even in the case where a customer wants to use a rental car from early in the morning, a car-rental agent can allocate a rental car at an appointed location in such time. Thereby it becomes possible to promote customer's convenience.

Besides, plural rental-car information control servers, each of which is set in each of the distinct car-rental agents, are connected to a fixing-up server. The fixing-up server inquires of each of the rental-car information control servers whether or not it is possible to allocate a rental car so as to satisfy reserving information. On the basis of the results of the replies, the fixing-up server(s) chooses a certain car-rental agent. Therefore a rental-car fixing-up agent can fix up a car-rental agent which can allocate a rental car so as to satisfy contents of reservation required.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A rental-car reservation method, in which it is possible to reserve a rental car through the Internet, wherein:
a car-rental fixing-up agent directs a car-rental agent to allocate a rental car on the basis of reserving information from a customer; and
the car-rental agent allocates the rental car at an appointed location at an appointed date, and goes to an appointed location at an appointed date so as to take back the rental car on the basis of the direction of allocating the rental car.

2. The rental-car reservation method as claimed in claim 1, wherein the car-rental fixing-up agent inquires of a plurality of car-rental agents whether or not it is possible to allocate the rental car so as to satisfy contents of the reservation, and chooses a car-rental agent which allocates the rental car for the customer on the basis of results of the replies from the plurality of the car-rental agents.

3. A rental-car reservation system, in which it is possible to reserve a rental car through the Internet, comprising:
a rental-car information control server which controls information of operating condition of rental cars; and
fixing-up servers which ask the rental-car information control server to allocate a rental car according to rental-car reserving information from a customer terminal, wherein leased lines are employed for connecting the fixing-up servers to the rental-car information control server.

4. A rental-car reservation system, in which it is possible to reserve a rental car through the Internet, comprising:
a rental-car information control server which controls information of operating condition of rental cars; and
fixing-up servers which ask the rental-car information control server to allocate a rental car according to rental-car reserving information from a customer terminal which means a terminal of a cellular phone or a communication terminal.

5. The rental-car reservation system as claimed in claim 3, wherein:
there are a plurality of rental-car information control servers; and
the fixing-up servers choose one of the rental-car information control servers according to the reserving information and asks the chosen rental-car information control server to allocate the rental car by inquiring of each of the plurality of the rental-car information control servers whether or not it is possible to issue instructions of allocating the rental car so as to satisfy contents of the reservation, and choosing the certain rental-car information control server on the basis of the results of the replies from each of the rental-car information control servers.

6. The rental-car reservation system as claimed in claim 4, wherein:
there are a plurality of rental-car information control servers; and
the fixing-up servers choose one of the rental-car information control servers according to the reserving information and asks the chosen rental-car information control server to allocate the rental car by inquiring of each of the plurality of the rental-car information control servers whether or not it is possible to issue instructions of allocating the rental car so as to satisfy contents of the reservation, and choosing a certain rental-car information control server on the basis of the results of the replies from each of the rental-car information control servers.

7. A recording medium in which rental-car reservation program for rental-car reservation is recorded, including steps of:
taking rental-car reserving information from a customer terminal;
inquiring of a plurality of rental-car information control servers each of which controls allocation of rental cars whether or not it is possible to issue instructions of allocating a rental car so as to satisfy contents of the reservation;
choosing one of the rental-car information control servers which can allocate the rental car so as to satisfy the contents of the reservation on the basis of the results of the replies from each of the rental-car information control servers; and
directing the chosen rental-car information control server to allocate the rental car.
